(19) United States
(12) Patent Application Publication
(10) Pub. No.: US 2004/0048666 A1
(43) Pub. Date: Mar. 11, 2004

(54) Wireless game device and method for using the same

(75) Inventors: Ronald D. Bagley, Dallas, TX (US); David S. Bowen, Auburn, NY (US); Kwong Shek Benedict Tsang, Tuen Mun (HK); Wai Ki Fung, Kowloon (HK); Yiu Keung Derek Man, Fanling (HK); Ray Chan, Kowloon (HK)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Radica China Limited

(21) Appl. No.: 10/237,965

(22) Filed: Sep. 10, 2002

(51) Int. Cl. G06F 17/00

(52) U.S. Cl. 463/39

(57) ABSTRACT

A game device for wireless communication with an electronic game, comprising a main body including, first and second light emitting members disposed on the main body and retained by first and second supports, each of the first and second supports including an open portion allowing concentrated beams of light to emit from the first and second light emitting members, respectively, in first and second axial substantially directions, respectively, for communicating with the electronic game.

### BACKGROUND OF THE INVENTION

Conventional video games often require the player to use control mechanisms, such as a joystick or keyboard, which must be wired to the video game console or software to command and play the video game. A player of these conventional video games is not actively participating in the play of the video game other than operating the joystick or keyboard. Additionally, the display of conventional video games is sometimes confined to a small display screen provided with the video game console.

### SUMMARY OF THE INVENTION

Accordingly, an object of the present invention is to provide a game device that enables playing of an electronic game via wireless commands, thus avoiding direct connection to the game device.

Another object of the present invention is to provide a game device that allows the player of an electronic game to actively and more realistically participate in the play of the game.

Yet another object of the present invention is to provide a game device that allows the movements of a player of an electronic game to be incorporated into the game.

Still another object of the present invention is to provide a game device that displays the movements of the player and the electronic game on a television screen.

The foregoing objects are basically attained by a game device for wireless communication with an electronic game and a method for using the same. The game device and method employ a main body including first and second light emitting members disposed on the main body and retained by first and second supports, with each of the first and second supports including an open portion allowing concentrated beams of light to emit from the first and second light emitting members, respectively, in first and second substantially different axial directions, respectively, for communicating with the electronic game.

The foregoing objects are also attained by a game device for wireless communication with an electronic game and a method for using the same, each employing a main body including, an inner compartment, a first infrared light emitting member disposed in the inner compartment and retained by a first support with an open portion, and a first motion sensor disposed on the main body and electrically connected to the first infrared light emitting member for triggering the first infrared light emitting member to emit a concentrated beam of infrared light through the open portion of the first retainer in a first axial direction for communication with the electronic game.

The foregoing objects are also attained by a game device for wireless communication with an electronic game, and method for using the same, each employing a main body including, a first light emitting member disposed on the main body and retained by a first support with an open portion, and first and second motion sensors disposed on the main body and electrically connected to the first light emitting member for triggering the first infrared light emitting member to emit a concentrated beam of infrared light through the open portion of the first support in a first axial direction for communication with the electronic game, the first and second motion sensors oriented in first and second substantially perpendicular planes, whereby the first and second motion sensors detect motion of the main body in both the first and second planes.

The foregoing objects are also attained by a game device for wireless communication with an electronic game, and method for using the same, each employing a main body including, an inner compartment, first, second and third infrared light emitting members disposed on the main body and retained by first, second and third substantially cylindrical casings, respectively, each of the first, second and third supports including an open end allowing concentrated beams of infrared light to emit from the first, second and third light emitting members, respectively, in first, second and third axial directions, respectively, each of the first, second and third axial directions being substantially different from one another, and first and second motion sensors disposed in the inner compartment of the main body and electrically connected to the first and second infrared light emitting members for triggering the infrared light beams for communication with the electronic game, the first and second motion sensors having first and second planar surfaces with the first planar surface being substantially perpendicular to the second planar surface, whereby the first and second motion sensors detect motion of the main body in both first and second planes defined by the first and second planar surfaces, respectively.

Other objects, advantages and salient features of the invention will become apparent from the following detailed description, which, taken in conjunction with annexed drawings, discloses a preferred embodiment of the present invention.

### BRIEF DESCRIPTION OF THE DRAWINGS

Referring to the drawings which form a part of this disclosure:

FIG. 1 is a perspective view of wireless game devices in accordance with an embodiment of the present invention, showing a player using the game devices to play an electronic game through a console and displayed on a television;

FIG. 2 is a detailed front perspective view of a wireless game device illustrated in FIG. 1, showing the orientation of light emitting members and motion sensors with respect to the game device;

FIG. 3 is a detailed perspective view of one of the light emitting members illustrated in FIG. 2;

FIG. 4 is a different perspective view of the wireless game device illustrated in FIGS. 1 and 2, showing the orientation of the light emitting members and the motion sensors with respect to the game device;

FIG. 5 is a top plan view of the wireless game device illustrated in FIGS. 1, and 4;

FIG. 6 is an exploded rear elevational view of the wireless game device illustrated in FIGS. 1, 2 and 4, showing the orientation of the light emitting members; and

FIG. 7 is a diagrammatic view of an example of components of the wireless game device illustrated in FIGS. 1, 2 and 4 according to an embodiment of the present invention, showing an example of the electrical connection between a microprocessor of the game device and the light emitting members and the motion sensors.

### DETAILED DESCRIPTION OF THE PREFERRED EMBODIMENT

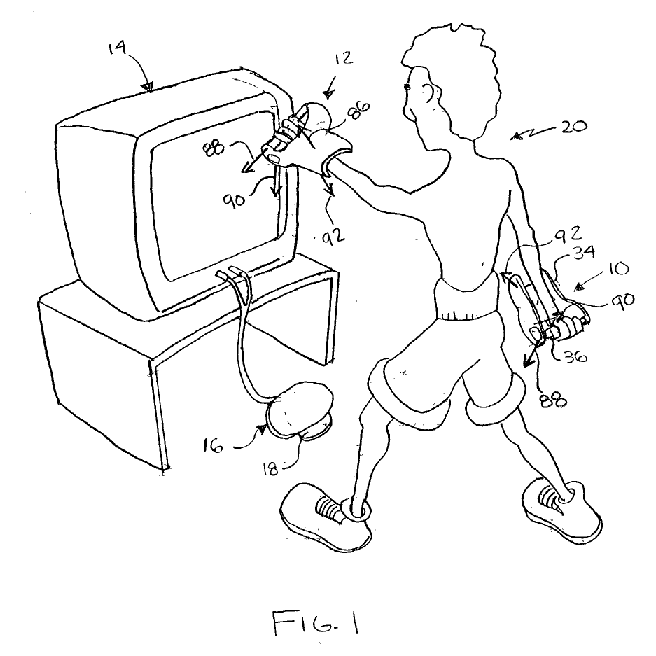

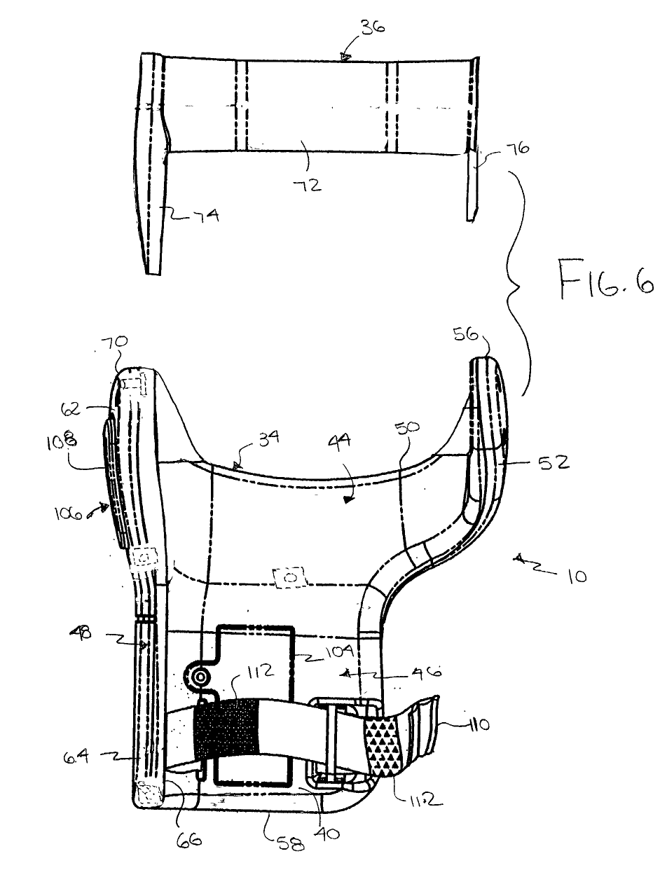

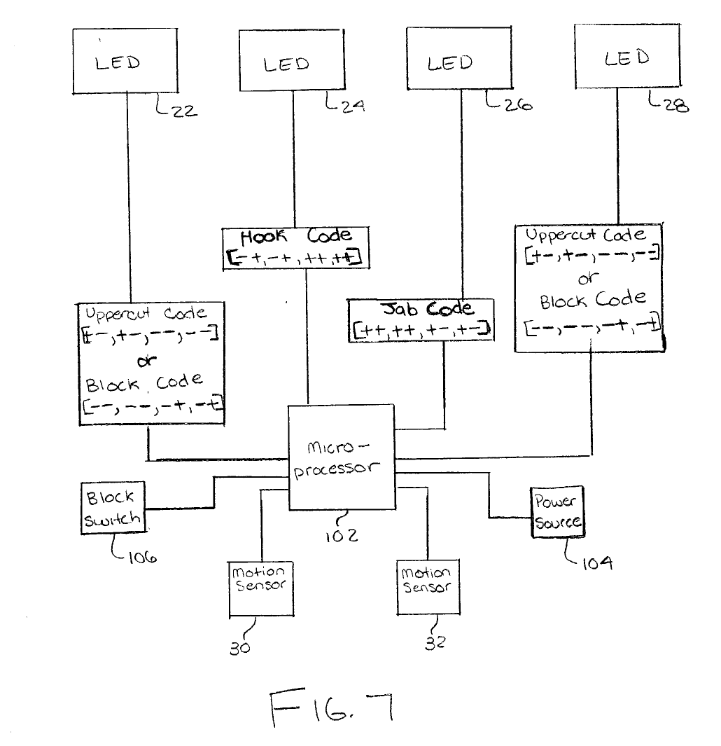

Referring to FIGS. 1-7, a game device 10 in accordance with an embodiment of the present invention is used for playing an electronic game, preferably a boxing video game, displayed on a video screen, such as a screen of a television 14, through a console 16. Console 16 includes a central processing unit employing and usable with software for running the video game, and a sensor 18 that receives wireless commands from game device 10 to play the video game. Preferably, game device 10 has a shape and appearance of a boxing glove and is worn by a player 20 of the video game, as best seen in FIG. 1. To facilitate description of the present invention, game device 10 is illustrated as a right handed boxing glove. However, a second game device 12 (see FIG. 1) that has the shape and appearance of a left handed boxing glove is also preferably used to play the video game.

Game devices 10 and 12 allow the player 20 to play the boxing video game simply by throwing punches with game devices 10 and 12 placed on the right and left hands of player 20. When player 20 throws punches while boxing, sensor 18 receives and recognizes wireless commands or communications from devices 10 and 12 corresponding to the types of punches thrown. Sensor 18 is adapted to communicate with the central processing unit of console 16 and the software of the video game to display the punches of player 20 on the television 14. Thus, as a player 20 is boxing, the player's thrown punches are incorporated into the play of the video game simulating boxing with another person and displayed on television 14.

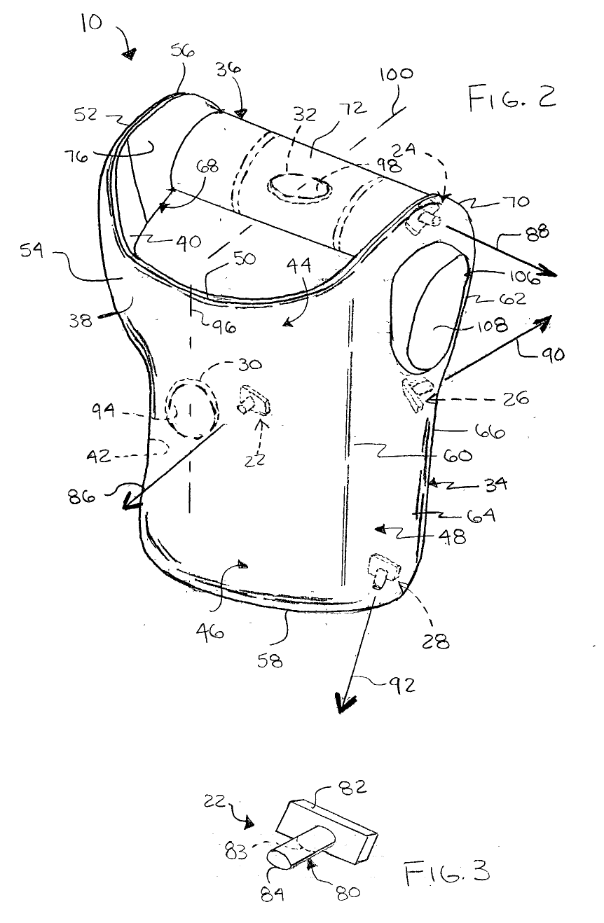

As best seen in FIGS. 2-7, in general, game device 10 includes first, second, third and fourth light emitting members 22, 24, 26 and 28, such as light emitting diodes (LEDs), which communicate to console 16 the type of boxing punch thrown by the player 20, and first and second motion sensors 30 and 32 that trigger the light emitting members 22, 24, 26 and 28. Although LEDs are preferably used with game device 10, any known type of light source or other suitable energy source can be used with light emitting members 22, 24, 26 and 28. Game device 12 is the identical or substantially the identical mirror image of game device 10 and therefore only game device 10 will be described in detail.

More specifically, game device 10 includes a main body 34 that covers the player's 20 forearm near the wrist and hand and a hand grip 36 at the end of main body 34. Main body 34 has a base 38 and a cover 40 attached in any known manner, such as by screws or adhesive. Base 38 and cover 40 form an inner compartment 42 for receiving first, second, third and fourth light emitting members 22, 24, 26 and 28 and at least one of first and second motion sensors 30.

Main body 34 is made up of first, second and third portions 44, 46 and 48, as seen in FIGS. 2, 4 and 6. First portion 44 is located near hand grip 36 and defines a first free edge wall 50 spaced from hand grip 36. A curved arm 52 extends from a side 54 of first portion 44 and terminates at a free end 56. Second portion 46 extends from first portion 44 opposite first free edge wall 50 and terminates at a second free edge wall 58. Third portion 48 extends along a common side 60 of first and second portions 44 and 46 opposite curved arm 52 and between first and second free edge walls 50 and 58 of first and second portions 44 and 46, respectively. Third portion 48 includes first and second sections 62 and 64 extending from first and second portions 44 and 46, respectively, and terminating at a free side edge wall 66. First and second sections 62 and 64 are curved to cover the outer side of the player's hand and forearm near the wrist. First section 62 of third portion 48 includes a connection end 70 for connecting to hand grip 36. A substantially semi-circular opening 68 is defined between first section 62 of third portion 48, first portion 44 and curved arm 52 for accommodating both hand grip 36 and the player's hand gripping hand grip 36.

As seen in FIGS. 2-6, hand grip 36 includes a substantially cylindrical member 72 that is hollow for receiving one of the first and second motion sensors 30 and 32. Hand grip 36 includes first and second end walls 74 and 76 that are connectable to curved arm 52 at freed end 56 and third portion 48 at connection end 70.

As seen in FIGS. 2, 4 and 6, first, second, third and fourth light emitting members 22, 24, 26 and 28 are received within inner compartment 42 of game device 10 and positioned to radiate or communicate to console 16 the type of punch thrown by player 20. In particular, each light emitting member 22, 24, 26 and 28 is positioned on device 10 so that console 16 and sensor 18 can recognize the type of punch being thrown. First light emitting member 22 is generally centrally oriented on main body 34 where first and second portions 44 and 46 meet. Second light emitting member 22 is generally oriented at the first section 62 of third portion 48 at the connection point of third portion 48 and hand grip first end wall 74. Alternatively, second light emitting member 22 is disposed on hand grip first end wall 74. Third light emitting member 24 is oriented at third portion 48 near the junction point of first and second sections 62 and 64 of third portion 48 and adjacent free side edge wall 66 of third portion 48. Fourth light emitting member 28 is located a second section 64 of third portion 48 near second edge wall 58. Although these are the preferred orientations of light emitting members 22, 24, 26 and 28, they can be positioned anywhere on either main body 34, hand grip 36 or both in any desired orientation to communicate with console sensor 18.

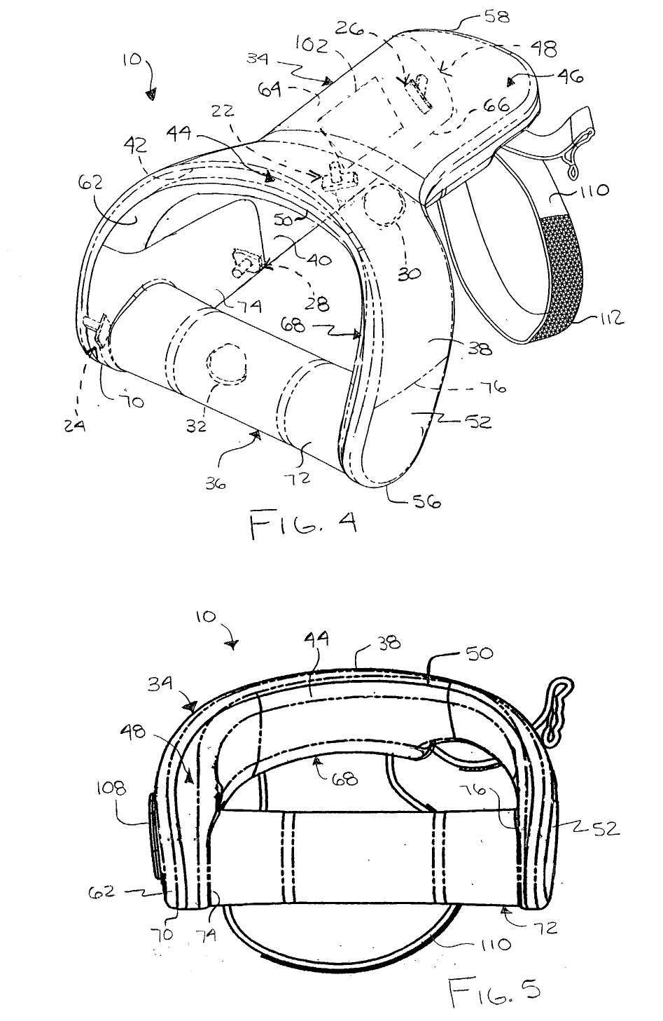

Each of first, second, third and fourth light emitting members 22, 24, 26 and 28 include supports or casings 80, as best seen in FIGS. 2 and 3 (FIG. 3 shows only one light emitting member 22 and one casing 80), preferably on the inner surface of base 38. Each casing 80 is substantially cylindrical and preferably includes an attachment wall 82 for mounting each first, second, third and fourth light emitting members 22, 24, 26 and 28 in a respective casing 80. An open portion or end 84 of each casing allows light to radiate therethrough from the respective bulb 83 of each light emitting member 22, 24, 26 and 28. Each of the first, second, third and fourth light emitting members 22, 24, 26 and 28 with casing 80, respectively, emit a concentrated beam of light through open end 84 of each casing 80. The shape of casing 80 acts to form a more concentrated light beam and light radiates from each bulb 83 of each light emitting member 22, 24, 26 and 28. Although, casing 80 is preferably used to support each light emitting member 22, 24, 26 and 28, any type of support or mounting can be used to secure each member 22, 24, 26 and 28 in place. Preferably, each light emitting member 22, 24, 26 and 28 uses infrared light, thereby allowing the light beams to penetrate main body 34 and hand grip 36, which are preferably made of plastic. However, light emitting members 22, 24, 26 and 28 can use non-infrared light and can also be mounted on the outside of main body 34 and 36 if desired.

As seen in FIG. 2, first light emitting member 22 radiates a beam of light in a first axial direction 86, second light emitting member 24 radiates a beam of light in a second axial direction 88, third light emitting member 26 radiates a beam of light in a third axial direction 90 and fourth light emitting member 28 radiates a beam of light in a fourth axial direction 92. Each beam of light radiating in a respective axial direction 86, 88, 90, 92 represents the type of punch thrown while the player 20 is boxing, such as a jab, hook or uppercut, and is received by sensor 18 of console. For example, the light emitted from first light emitting member 22 can represent an uppercut, the light emitted from second light emitting member 24 can represent a hook, the light emitted from third light emitting member 26 can represent a jab and the light emitted from fourth light emitting member 28 can represent uppercut. However, each light emitting member 22, 24, 26 and 28 can represent any type of punch, respectively.

Preferably, each axial direction 86, 88, 90 and 92 is different from one another. For example, first axial direction 86 and second axial direction 88 are generally perpendicular to one another and first and third axial directions 86 and 90 are generally parallel but extending in opposite directions. Fourth axial direction 92 is acutely angled from first axial direction 88. However, first, second, third and fourth axial directions can be oriented and angled in any fashion appropriate to communicate to console sensor 18 the movement of game device 10.

As seen in FIGS. 2 and 4, first and second motion sensors 30 and 32 act to trigger first, second, third and fourth light emitting members 22, 24, 26 and 28 upon movement of game device 10. First and second motion sensors 30 and 32 are located in first and second planes that are preferably substantially perpendicular to one another to allow motion detection in more than one plane. Each motion sensor 30 and 32 is a conventional piezo motion sensor, but can be any type of motion sensor as known in the art. First motion sensor 30 has a substantially disc shape with a main planar surface 94 lying in the first plane defined along axis 96, as best seen in FIG. 2. First motion sensor 30 is preferably mounted to the inner surface of base 38 in inner compartment 42 near the junction of first and second portions 44 and 46 of main body and close to first light emitting member 22. Second motion sensor 32 also has a substantially disc shape with a main planar surface 98 lying in the second plane defined along axis 100 and substantially perpendicular to the first plane. Second motion sensor 32 is preferably mounted centrally within hand grip cylindrical member 72. Any type of mounting mechanism can be used to secured first and second motion sensors 30 and 32 such as screws, brackets or adhesive, as long as the main planar surfaces 94 and 98 are in different planes. Motion sensors 30 and 32 can also be secured to the outside of either main body 34 and hand grip 36, respectively, instead of within inner compartment 42.

A microprocessor 102 electrically connected to a power source 104, such as a battery, is preferably disposed within inner compartment 42 and mounted on base 38 at the second section 64 of the main body third portion 48, as best seen in FIG. 4. Microprocessor 102 is electrically connected to each light emitting member 22, 24, 26 and 28 and motion sensors 30 and 32, as seen in FIG. 7. Microprocessor 102 is programmed to energize on all light emitting members 22, 24, 26 and 28 upon motion being detected by motion sensors 30 and 32. Also, microprocessor 102 provides codes to each member 22, 24, 26 and 28, that are already programmed into microprocessor 102, and are received and recognized by console sensor 18 and by the console central processing unit, as corresponding to a type of punch.

Each code is a particular on/off pulse sequence of light within a predetermined amount of time. Thus, each light emitting member 22, 24, 26 and 28 will radiate their respective light beam in a particular on and off sequence for a period of time to communicate with console 16 which punch is being thrown by the player 20. Preferably, each code or sequence is made up of 4 groups of 2 on/off pulses for a predetermined about of time. For example, if “on” and “off” are represented by “+” and “−” then one code for an uppercut punch could be [+−; −−; +−; −−] with each group of 2 on/off pulse lasting for a period of 3.5 milliseconds for a total of 14 milliseconds. Any combination of on/off pulses can be used for each punch as long as a different code is assigned to each type of punch. Since there are three different types of punches, i.e. an uppercut, hook and jab, three different codes or pulse sequences are programmed into microprocessor 102 for each punch and respective light emitting member. Because first and fourth light emitting members 22 and 28 preferably represent the same punch, i.e. uppercut, only one code is provided to both of these light emitting members. FIG. 7 illustrates examples of different codes selected for each light emitting member 22, 24, 26 and 28 and representing either an uppercut, hook or jab. Also, it is preferable to use different codes for the right and left handed game devices 10 and 12. Thus, if there are three different types of punches for each of the right and left handed game devices 10 and 12, six different codes or pulse sequences are programmed into the microprocessor of each device for providing the appropriate code or pulse sequence to each light emitting member.

Game device 10 can optionally include a switch 106 that represents a block thrown by the player 20 rather than a punch. Switch 106 includes a button 108 located in first section 62 of main body third portion 48 and operates an electrical switch preferably disposed on hand grip first end wall 74 and electrically connected to microprocessor 102. Switch 106 is connected to at least one of light emitting members 22, 24, 26 and 28, such as first light emitting member 22, through microprocessor 102, as best seen in FIGS. 2 and 7. When button 106 is depressed by the player 20, switch 106 communicates that a block is being thrown to the microprocessor 102 which provides an appropriate pulse code, in the same manner as described above, to first light emitting member 22. The pulse code or sequence for the block is different than the pulse codes assigned to an uppercut, hook or jab, as described above. Block switch 106 can be connected to more than one light emitting member, such as to both first and fourth light emitting members 22 and 28, as seen in FIG. 7.

### Operation

Referring to FIGS. 1-7, game devices 10 and 12 operate using wireless commands to communicate with the central processing unit of console 16 allowing a player 20 to play the video game programmed into the central processing unit and display it on television 14. The player's 20 boxing punches are incorporated into the video game substantially simultaneously with the player's movements. Game devices 10 and 12 are placed on the right and light hands of the player 20, respectively, by inserting the player's 20 hands through openings 68 between hand grip 36 and main body 34 of each device 10 and 12. Player 20 can then grab hand grip 36 of each game device 10 and 12. A strap 110 attached to cover 40 and having hook and loop fasteners 112 thereon can be used with each game device 10 and 12 to secure the devices to the player's 20 hands. Console 16 is placed in front of television 14 and at the feet of player 20 with sensor 18 generally facing the player 20, as seen in FIG. 1.

Upon movement of the player 20, motion sensors 30 and 32 in each device 10 and 12 will trigger, via microprocessor 102, each light emitting member 22, 24, 26 and 28 of each game device 10 and 12 to turn on. Microprocessor 102 provides the appropriate pulse code sequence to each light emitting member 22, 24, 26 and 28 corresponding to a punch, as seen in FIG. 7. As the player boxes and throws a particular punch using either device 10 and 12, sensor 18 will receive and recognize the light beam from the light emitting member 22, 24, 26 or 28 representing that punch, because the particular pulse code or sequence radiating from the light emitting member communicates the type of punch to sensor 18 and the central processing unit, as discussed above. The cylindrical shape of casing 80 provides a concentrated light beam from the respective light emitting member, thereby facilitating communication with console sensor 18. The central processing unit of the console 16 then incorporates that punch into the video game and displays the same on the television 14. The same is done for every punch thrown by player 20, thereby simulating a boxing match of player 20 with another person.

For example, if first and fourth light emitting members 22 and 28 represent an uppercut punch, and player 20 throws an uppercut, either the light beam radiating from first emitting member 22 in the first axial direction 86 or the light beam radiating from fourth emitting member 28 in the fourth axial direction 92 will be sensed and received by console sensor 18. Because first and fourth light emitting members 22 and 28 are assigned a unique pulse code for an uppercut and radiate the same, the uppercut will be recognized by the sensor 18 and the central processing unit of console 16 and incorporated into the video game and displayed on television 14. Similarly, if second and third light emitting members 24 and 26 represent a hook and a jab, respectively, and player 20 throws either a hook or a jab, console sensor 18 and the central processing unit will recognize the pulse sequence of either a hook or a jab and incorporate it into the video game being display on the television 14. The player 20 can also depress switch 106 representing a block with one or more of the light emitting members 22, 24, 26 and 28 radiating the unique pulse sequence of a block to sensor 18 and the central processing unit of console 20 to be incorporated into the game.

While a particular embodiment has been chosen to illustrate the invention, it will be understood by those skilled in the art that various changes and modifications can be made therein without departing from the scope of the invention as defined in the appended claims. For example, game device 10 can be used with other types of games such as sword play or baseball. In the case of either sword play or baseball, the video game would simulate player 20 having a sword fight with another person or hitting a baseball with a baseball bat. Game device 10 would be shaped like a sword or baseball bat, respectively, with each light emitting member 22, 24, 26 and 28 being oriented to communicate the movement of the sword or swinging of the baseball bat in the same manner as described above.

What is claimed is:

1. A game device for wireless communication with an electronic game, comprising:
a main body including, first and second light emitting members disposed on said main body and retained by first and second supports, each of said first and second supports including an open portion allowing concentrated beams of light to emit from said first and second light emitting members, respectively, in first and second substantially different axial directions, respectively, for communicating with the electronic game.

2. A game device in accordance with claim 1, wherein a first motion sensor is disposed on said main body and is electrically connected to said first and second light emitting members for triggering said beams of light.

3. A game device in accordance with claim 2, wherein a second motion sensor is disposed on said main body and electrically connected to said first and second light emitting members; and
said first and second motion sensors are oriented in first and second substantially perpendicular planes, to detect motion of said main body in both said first and second planes.

4. A game device in accordance with claim 1, wherein
said second axial direction is substantially perpendicular from said first axial direction.

5. A game device in accordance with claim 1, wherein
said second axial direction is substantially opposite from and substantially parallel to said first axial direction.

6. A game device in accordance with claim 5, wherein
said first and second axial directions are axially spaced from one another.

7. A game device in accordance with claim 1, wherein
said main body includes a third light emitting member retained by a third support, said third support includes an open portion allowing a concentrated beam of light to emit from said third light emitting member in a third axial direction, respectively, for communicating with the electronic game, and said third axial direction being substantially different than each of said first and second axial directions, respectively.

8. A game device in accordance with claim 7, wherein
said main body includes a fourth light emitting member retained by a fourth support, said fourth support includes an open portion allowing a concentrated beam of light to emit from said fourth light emitting member in a fourth axial direction, respectively, for communicating with the electronic game, and said fourth axial direction being substantially different than each of said first, second and third axial directions, respectively.

9. A game device according to claim 1, wherein
said first and second supports are first and second substantially cylindrical casings surrounding said first and second light emitting members, respectively; and
said open portions of said first and second supports are open ends of said first and second casings.

10. A game device according to claim 1, wherein
each of said concentrated beams of light of said first and second light emitting members, respectively, have a respective code for communication with the electronic game; and
each of said codes are a sequence of on and off pulses of light within a predetermined time interval, with each code being different from one another.

11. A game device according to claim 10, wherein
said codes are programmed into a microprocessor disposed in said main body and electrically connected to said first and second light emitting members for providing said codes to said first and second light emitting members.

12. A game device according to claim 1, wherein
a switch is connected to said microprocessor for change the code of at least one of said first and second light emitting members.

13. A game device according to claim 1, wherein
said main body has a glove shape; and
said first and second light emitting members are received within an inner compartment of said main body.

14. A game device according to claim 1, wherein
a hand grip is coupled to said main body defining an opening between said hand grip and said main body allowing the hand of a player to extend therethrough and grip said hand grip.

15. A game device for wireless communication with an electronic game, comprising:
a main body including,
an inner compartment,
a first infrared light emitting member disposed in said inner compartment and retained by a first support with an open portion, and
a first motion sensor disposed on said main body and electrically connected to said first infrared light emitting member for triggering said first infrared light emitting member to emit a concentrated beam of infrared light through said open portion of said first retainer in a first axial direction for communication with the electronic game.

16. A game device according the claim 15, wherein
said main body includes a second infrared light emitting member disposed in said inner compartment and retained by a second support, said second support includes an open portion allowing a concentrated beam of infrared light to emit from said second light emitting member in a second axial direction, respectively, for communicating with the electronic game, and said second axial direction being substantially different than said first axial direction.

17. A game device according to claim 16, wherein
said main body has a glove shape; and
a hand grip is coupled to said main body for gripping by a player.

18. A game device according to claim 16, wherein
said main body includes a third and fourth infrared light emitting members disposed in said inner compartment and retained by a third and fourth supports, respectively, each of said third and fourth supports includes an open portion allowing a concentrated beam of infrared light to emit from said third and fourth light emitting members in third and fourth axial directions, respectively, for communicating with the electronic game, and said third and fourth axial directions being substantially different than each other and from each of said first and second axial directions, respectively.

19. A game device according to claim 16, wherein said
said first and second supports are first and second substantially cylindrical casings surrounding said first and second light emitting members, respectively; and
said open portions of said first and second supports are open ends of said first and second casings.

20. A game device for wireless communication with an electronic game, comprising:
a main body including,
a first light emitting member disposed on said main body and retained by a first support with an open portion, and
first and second motion sensors disposed on said main body and electrically connected to said first light emitting member for triggering said first infrared light emitting member to emit a concentrated beam of infrared light through said open portion of said first support in a first axial direction for communication with the electronic game, said first and second motion sensors being oriented in first and second substantially perpendicular planes to detect motion of said main body in both said first and second planes.

21. A game device according to claim 20, wherein
said main body includes a second and third light emitting members retained by a second and third supports, said second and third support includes an open portion allowing concentrated beams of light to emit from said second and third light emitting members in second and third axial directions, respectively, for communicating with the electronic game, and said second and third axial directions are substantially different than each other and from said first axial direction.

22. A game device according to claim 20, wherein
each of said first and second motion sensors has the shape of a planar disc with a planar surface; and
each of said planar surfaces of said first and second motion sensors, respectively, are parallel to said first and second planes, respectively.

23. A game device according to claim 20, wherein
each of said first light emitting member and said first and second motion sensors, respectively, are received in an inner compartment of said main body.

24. A game device according to claim 20, wherein
said first support is a substantially cylindrical casing; and
said open portion is an open end of said cylindrical casing.

25. A game device for wireless communication with an electronic game, comprising:
a main body including,
an inner compartment,
first, second and third infrared light emitting members disposed on said main body and retained by first, second and third substantially cylindrical casings, respectively, each of said first, second and third supports including an open end allowing concentrated beams of infrared light to emit from said first, second and third light emitting members, respectively, in first, second and third substantially different axial directions, respectively, and
first and second motion sensors disposed in said inner compartment of said main body and electrically connected to said first and second infrared light emitting members for triggering said infrared light beams for communication with the electronic game, said first and second motion sensors having first and second planar surfaces with said first planar surface being substantially perpendicular to said second planar surface to enable said first and second motion sensors to detect motion of said main body in both first and second planes defined by said first and second planar surfaces, respectively.
